(19) United States
(12) Patent Application Publication
(10) Pub. No.: US 2015/0014294 A1
(43) Pub. Date: Jan. 15, 2015

(54) METHOD AND SYSTEM FOR MELTING FROST AND/OR RIME AND/OR ICE AND/OR SNOW ON THE WINDOW OF A VEHICLE

(71) Applicant: Valeo Systèmes d'Essuyage, Le Mesnil Saint Denis (FR)

(72) Inventors: Christophe Dubosc, Pantin (FR); Frédèric Giraud, Le Perray en Yvelines (FR); Marcel Trebouet, Chavenay (FR)

(21) Appl. No.: 14/379,558

(22) PCT Filed: Feb. 21, 2013
(86) PCT No.: PCT/EP2013/053498

§ 371 Date: Aug. 19, 2014

(30) Foreign Application Priority Data
Feb. 22, 2012 (FR) 1251587

(51) Int. Cl. B60S 1/38

(52) U.S. Cl. CPC B60S 1/3805
USPC 219/203; 15/250.06

(57) ABSTRACT

The invention relates to a method and system for melting frost and/or rime and/or ice and/or snow on the window of a motor vehicle using a wiper blade (1) arranged so as to provide heat to the window (2) according to a melting cycle associated with an upward phase or falling phase of the blade, the method comprising the step of causing heat to provided to the window (2) by means of the wiper blade (1) such that said provision of heat melts the frost and/or rime and/or ice and/or snow on the window (2) of the vehicle, wherein said provision can be carried out in particular by radiating heat or spraying a heated liquid.

The present invention relates to a method for melting frost and/or ice and/or snow present on the window of a vehicle, using a wiper blade.

Patent Application FR 2 933 931 describes a method and a system for deicing a motor vehicle window using at least one wiper blade able to sweep a wiping zone of the window, the wiper blade being provided with a device for spraying washing fluid. That application teaches bringing the wiper blade into a deicing position inside the wiping zone and, once this position is reached, initiating the device for spraying washing fluid.

However, that method has a disadvantage. Specifically, as the wiper blades are in operation before they reach the deicing position the blades cover a distance on the window that has not been deiced, and this gives rise to accelerated wear of the wiper blade rubbers as a result of prolonged friction between the elastomer of the wiper blade rubbers and the abrasive surface formed by the rime present on the window.

In addition, at extremely cold temperatures, the mixture of washer fluid and water, resulting from the melting of the rime on the window, may re-freeze after the blade has moved past, thus reducing the effectiveness of the deicing operations.

One object of the invention is notably to propose a method for melting the frost and/or rime and/or ice and/or snow present on the window of a vehicle without inducing excessive wiper blade rubber wear and at the same time ensuring optimum deicing.

This object is achieved, according to the present invention, by virtue of a method for melting frost and/or rime and/or ice and/or snow present on a motor vehicle window, using a wiper blade designed to supply heat to the window in a melting cycle associated with an upstroke or downstroke of the blade, the method comprising the following steps:
causing the wiper blade to supply heat to the window in such a way that this supply of heat causes the frost and/or rime and/or ice and/or snow present on the vehicle window to melt,
in a first sequence, moving the wiper blade to sweep a first swept area, this first area being delimited by a starting position of the blade and an extreme position of the blade in this first sequence,
in a second sequence, moving the wiper blade to sweep a second swept area delimited by a starting position of the blade and an extreme position of the blade in this second sequence,
   characterized in that the first sequence and the second sequence cause the blade to move in the same direction in the same melting cycle.

With such a method according to the invention, the frost and/or rime and/or ice and/or snow present on the window is melted sequentially.

In other words, the first sequence is associated with a first starting position and with a first extreme position, then the second sequence is associated with a second starting position and with a second extreme position.

A sequence is defined by a movement of the wiper blade rubber from a starting position to an extreme position. The sequence is associated with a swept area. Stringing the sequences together forms a melting cycle which covers the entirety of the wiping zone. A melting cycle is associated with an upstroke of the blade or with a downstroke of the blade over the windshield. What that means is that the melting cycle covering the entire wiping zone is defined between what is commonly referred to as the blade parking position and the opposite fixed stopping position of the blade. The blade parking position is the position in which the blade lies when not in motion, in most cases this is a horizontal position toward the bottom of the windshield. By contrast, the opposite fixed stopping position of the blade corresponds to the position in which the blade has moved across the entire wiping zone and lies in a position in which it can go no further and in which it will be forced to come back in the opposite direction. In the case of a blade upstroke melting cycle, the melting cycle will extend between the parking position, which is also the starting position for the first sequence, and the opposite fixed stopping position which corresponds to the extreme position of the last sequence associated with the melting cycle.

Conversely, in the case of a blade downstroke melting cycle, the melting cycle will extend between the opposite fixed stopping position which corresponds to the extreme position of the last sequence associated with the upstroke melting cycle and the parking position, which is also the starting position for the first sequence of the upstroke melting cycle. In other words, the starting position for the first sequence of the downstroke melting cycle is the same as the extreme position of the last sequence of the upstroke melting cycle. Likewise, the extreme position of the last sequence associated with the downstroke melting cycle is the same as the starting position of the first sequence of the upstroke melting cycle.

According to a first embodiment of the invention, the first sequence, that defines a first swept area, comprises a starting position and an extreme position. The second sequence comprises a starting position and an extreme position, and the starting position of the second sequence comprises a position which is identical to the starting position of the first sequence. Advantageously, the extreme position of the second sequence lies at least partially outside the first swept area.

In other words, the starting position during the melting cycle will be the same whatever the sequence. In a particularly advantageous manner, there may be a pause when the blade reaches the extreme position of each sequence so that the zone containing frost and/or rime and/or ice and/or snow near the wiper blade can melt.

This means that zones of the windshield can be gone over a great many times thus ensuring effective melting.

According to a second embodiment of the invention, the first sequence, that defines a first swept area, comprises a starting position and an extreme position. The second sequence comprises a starting position and an extreme position, the starting position for this second sequence being identical to the extreme position of the first sequence. In this embodiment, the starting position of the first sequence is distinct from the starting position of the second sequence. In a particularly advantageous manner, there is a pause between the first and second sequence so that the zone comprising frost and/or rime and/or ice and/or snow near the windshield wiper blade can melt.

According to a third embodiment of the invention, the first sequence, that defines a first swept area, comprises a starting position and an extreme position. The second sequence comprises a starting position and an extreme position, the starting position of the second sequence is different than the starting position of the first sequence.

Specifically, the starting position of the second sequence lies at least partially inside the first swept area, set back from the extreme position of the first sequence.

Advantageously, the extreme position of the second sequence is situated at least partially outside the first swept area.

The fact that the starting position for the second sequence is situated at least partially inside the first swept area means that a zone that has already been swept can be gone over again increasing the melting of the frost and/or rime and/or ice and/or snow and ensuring immediate removal of residual water or water mixed with washer fluid. That very advantageously prevents the window from refreezing after the wiper blade rubber has gone over it.

As an alternative to these embodiments, the first sequence is initiated at least twice before the second sequence is begun in order to effectively deice an area of the vehicle window before beginning the next sequence.

In one exemplary embodiment of the invention, when sequences are strung together, the first sequence is immediately followed by the second sequence and so on until an upstroke or downstroke melting cycle is formed that covers the entirety of the wiping zone.

For optimum melting of the frost and/or rime and/or ice and/or snow there may be a pause between the first sequence and the second sequence. More particularly, the pause may come when the blade is in its extreme position in a sequence.

Advantageously, this pause can be calculated as a function of the external ambient temperature by the vehicle, or alternatively as a function of the thickness of frost and/or rime and/or ice and/or snow on the windshield. The lower the temperature, the longer the pause will be, just as if the quantity of frost and/or rime and/or ice and/or snow is great, the pause will likewise be longer. For example, the pause may be predetermined, and preferably comprises between 1 and 10 seconds and more particularly between 3 and 6 seconds.

During this pause, heat is supplied by the wiper blade to the window so as to increase the effectiveness with which the frost and/or rime and/or ice and/or snow is melted around the zone in which the blade is situated.

As an alternative, the supply of heat by the wiper blade to the window is continuous during the first sequence and the second sequence.

In one embodiment of the invention, the number of sequences required to perform a melting cycle is predetermined.

According to a preferred embodiment, the number of sequences needed may thus be independent of the weather conditions. This makes it possible to avoid the use for example of sensors which may prove expensive. In a particularly advantageous manner, the number of sequences needed to carry out a melting cycle is predetermined, and a minimum of 5 sequences.

In another embodiment, the number of sequences needed to perform a melting cycle is dependent on information relating to the state of the window and/or weather conditions. This information relates for example to the amount of frost and/or rime and/or ice and/or snow present on the window. The information notably allows the number of sequences to be optimally adjusted in order best to deice the window.

Another subject of the invention is a system for melting frost and/or rime and/or ice and/or snow present on a motor vehicle window, using a wiper blade designed to supply heat to the window according to a melting cycle associated with an upstroke or downstroke of the blade, the system comprising:
the wiper blade able to melt the frost and/or rime and/or ice and/or snow present on the vehicle window,
a control unit designed to actuate the blade in the following steps:
   causing the wiper blade to supply heat to the window so that this supply of heat causes the frost and/or rime and/or ice and/or snow present on the vehicle window to melt,
   in a first sequence, moving the wiper blade so as to sweep a first swept area, this first area being delimited by a starting position of the blade and an extreme position of the blade in this first sequence,
   in a second sequence, moving the wiper blade to sweep a second swept area delimited by a starting position of the blade and an extreme position of the blade in this second sequence,
      characterized in that the first sequence and the second sequence cause the blade to move in the same direction in the same melting cycle.

In one embodiment of the invention, the control unit is designed to actuate the blade in a predetermined number of sequences, this number advantageously being stored in memory beforehand, for example at the time of manufacture of the vehicle, and may be at minimum 5 sequences in order to carry out the melting cycle. Likewise, the control unit is also designed to stop the blade between the sequences or alternatively when the blade is in the extreme position. This pause is stored in memory beforehand and is, for example, between 1 and seconds and more particularly between 3 and 6 seconds.

According to another embodiment, the control unit is connected to at least one detector detecting the state of the window which is able for example to detect the quantity of frost and/or rime and/or ice and/or snow present on the window and/or deliver information regarding the weather conditions.

For example, the information about the quantity of frost and/or rime and/or ice and/or snow provided by the detector is received by the control unit, for example incorporated into the vehicle onboard electronics, and the control unit where appropriate automatically initiates the sequences for melting the frost and/or rime and/or ice and/or snow and automatically adapts the number of sequences to be carried out to suit the detected quantity of frost and/or rime and/or ice and/or snow. In this respect, the greater the amount of frost and/or rime and/or ice and/or snow detected, the higher the number of sequences in order to optimize melting. By contrast, if the quantity of frost and/or rime and/or ice and/or snow present on the window is low, the number of sequences is lower.

In another example, the control unit determines the length of pause between the sequences or alternatively the length of pause when the blade reaches the extreme position in a sequence. This pause allowing heat to be supplied to the window and, in this respect, the greater the detected quantity of frost and/or rime and/or ice and/or snow, the longer the pause in order to optimize melting. By contrast, if the quantity of frost and/or rime and/or ice and/or snow present on the window is low, the pause is shorter.

The control unit may comprise an actuator that can be actuated by a user of the vehicle in order to initiate the method. This actuator may, for example, be the wiper control lever, also referred to as the multi-function control stalk.

According to another embodiment, the control unit may comprise an actuator that can be actuated remotely away from the vehicle, for example by mobile phone or any other communications system capable of communicating remotely with the control unit.

The invention also relates to a wiper blade for a vehicle window, this blade comprising at least one thermal element designed to emit heating radiation toward the window when the blade is resting against this window, the radiation being of sufficient intensity to cause the frost and/or rime and/or ice and/or snow present on the window to melt in a wiping zone of the blade.

Advantageously, the thermal element is a radiant element and the radiation emitted by this thermal element is preferably of the infrared type. One particular feature of this type of infrared radiation heating is that it does not heat up the air but only heats up the solid materials that the radiation reaches.

The thermal power radiated by this thermal element can be chosen according to various parameters, for example according to the electrical power available in the vehicle, the chosen duration for the melting cycle, the geographical zone in which the vehicle is to be marketed, etc.

This radiated thermal power may for example be a few kW/m².

In one embodiment, the thermal element comprises a radiant body, notably made of ceramic, and a heating wire encapsulated inside this radiant body.

The blade may comprise at least two thermal elements positioned one on each side of a blade rubber of the wiper blade and substantially symmetric with one another about a plane passing through the longitudinal axis of the blade. For preference, the two thermal elements are able to operate simultaneously.

The wiper blade rubber is intended to come into contact with the window to wipe the window of the vehicle.

Advantageously, the thermal element extends over the majority of the length of the blade and preferably over substantially the entire length of the blade.

If desired, the thermal element is positioned at least partially in a cavity of the blade. This cavity can be obtained at the time of manufacture of the blade, for example in an extrusion operation. This cavity has, for example, a cross section of advantageously parabolic shape.

In one exemplary embodiment of the invention, the thermal element is at the focus of the cavity, to allow optimum radiation toward the window.

In another embodiment of the invention, the thermal element has a shape that substantially at least partially mimics the cavity, notably a closed end of this cavity.

For preference, the cavity extends over at least the majority of the length of the blade, notably over substantially the entire length of the blade.

The blade advantageously comprises two cavities situated one on each side of the blade rubber and may be substantially symmetric with respect to one another about a plane passing through the longitudinal axis of the blade.

The cavity may be open toward the window so that the thermal element emits the radiation effectively toward the window.

The cavity may comprise a reflective wall designed to reflect toward the window at least some of the radiation emitted by the thermal element, this reflective wall being made for example of aluminum.

Optionally, the cavity is at least partially closed by a protective element that allows the radiation emitted by the thermal element to pass through so as to protect the thermal element from external attack.

The thermal element is advantageously arranged on the blade in such a way as to be able to be powered by electrical energy from the vehicle in order to emit the radiation.

In an alternative form of embodiment, the thermal element designed to emit heating radiation is a heated fluid sprayed by the wiper blade. In the known way, there are types of windshield wiper blade capable of spraying heated fluid onto the surface that is to be cleaned via a multitude of openings along the entirety of the length of the windshield wiper blade. This fluid, heated by resistive elements of the PTC (positive temperature coefficient) type for example, allows heat to be supplied to the window.

Other advantages and specifics of the invention will become apparent from the description of some embodiments which is given hereinafter with reference to the attached drawings in which:

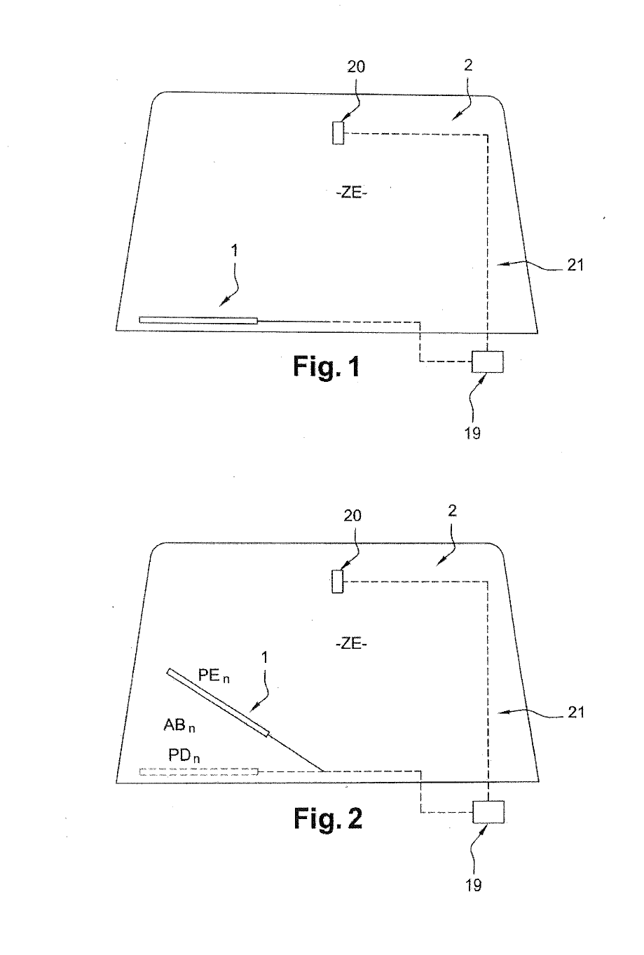

FIG. 1 illustrate the wiper blade 1 designed to supply heat to the window 2,

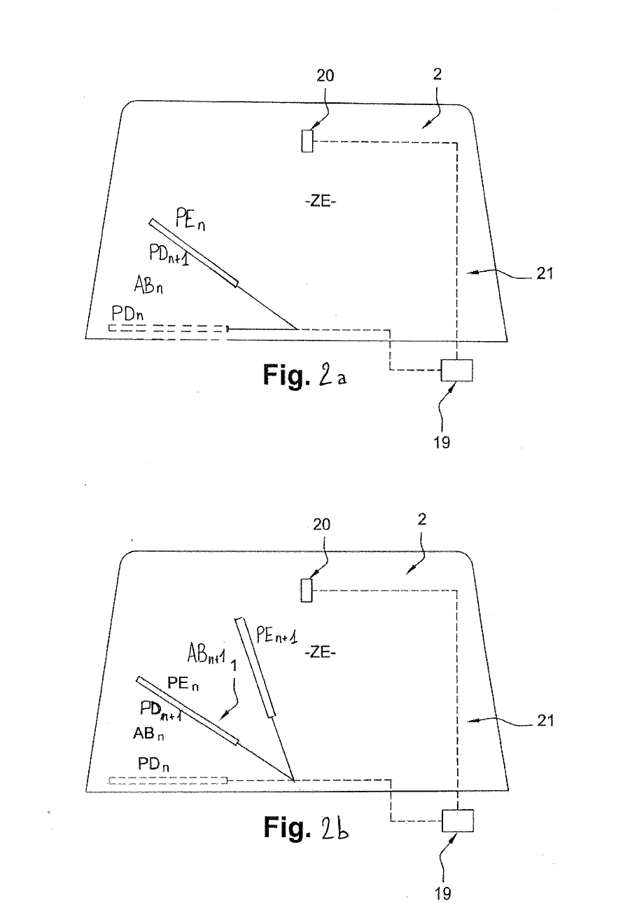

FIG. 2 is a view depicting the first sequence of an upstroke melting cycle,

FIGS. 2a and 2b illustrate the method according to the second embodiment of the invention,

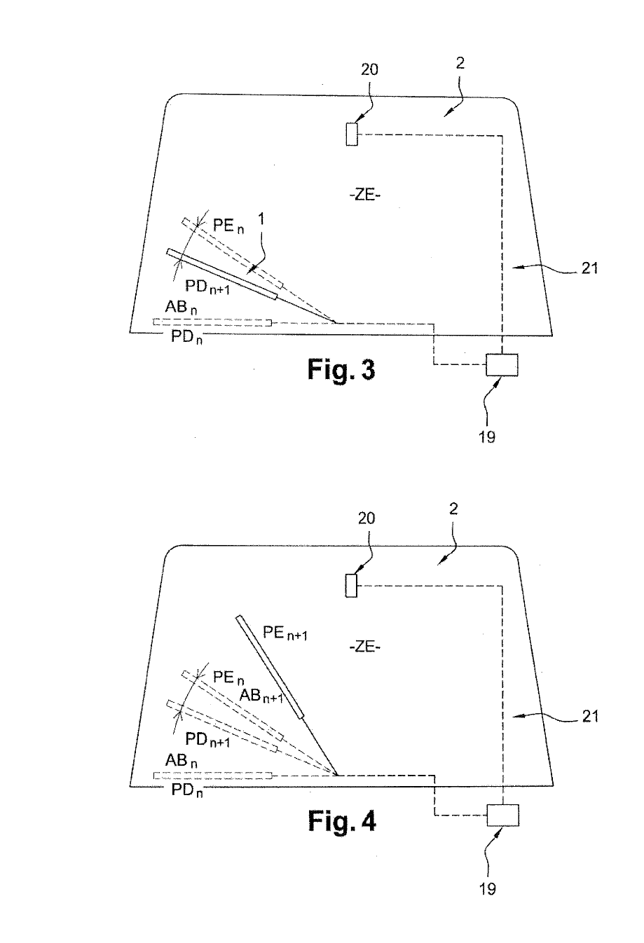

FIGS. 3 and 4 illustrate the method according to the first and third embodiment of the invention,

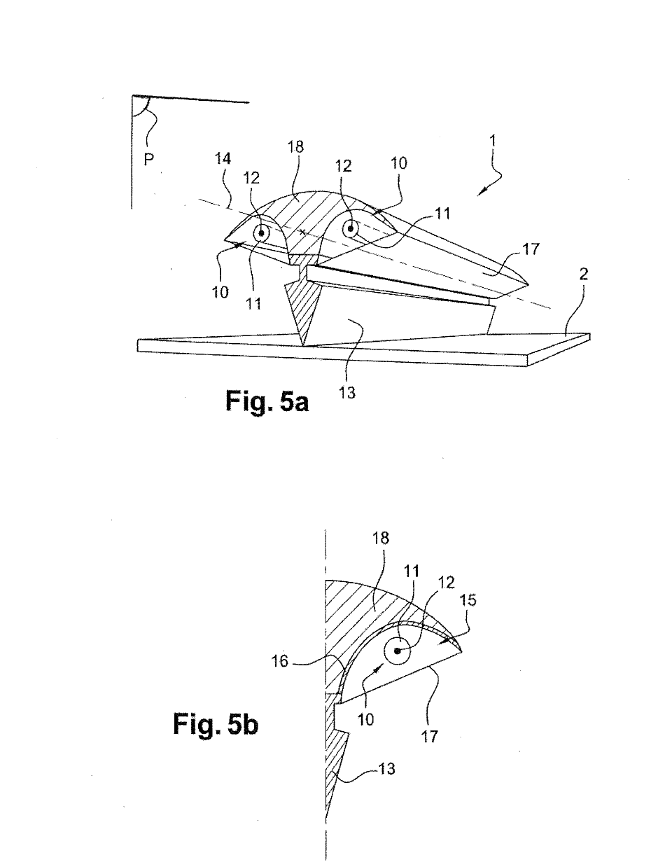

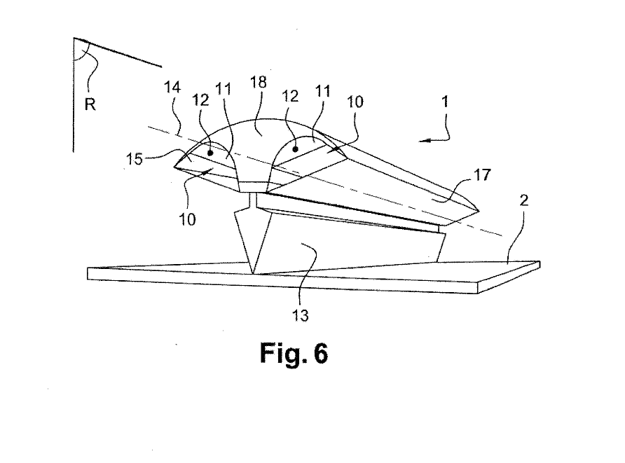

FIGS. 5a and 6 is schematic and partial views in perspective of a wiper blade according to two embodiments of the invention, and

FIG. 5b is a schematic and partial view in cross section of a wiper blade according to the embodiment of FIG. 5a.

FIG. 1 depicts a motor vehicle window 2 and a wiper blade 1 designed to supply heat to the window 2 in order, if necessary, to melt frost and/or rime and/or ice and/or snow present on this window 2. The wiper blade 1 is able to sweep a wiping zone ZE.

This FIG. 1 also depicts a system 21 according to one exemplary embodiment of the invention, the system comprising:
the wiper blade 1 details of which are described later on,
a control unit 19 designed to actuate the blade 1 according to the following steps:
   causing the wiper blade 1 to supply heat to the window 2 in such a way that this supply of heat causes the frost and/or rime and/or ice and/or snow present on the vehicle window 2 to melt, according to a melting cycle associated with an upstroke or downstroke of the blade,
   moving the blade 1 in sequences described later on.

The control unit 19 is connected to a detector 20 of the state of the window, it being possible for this detector 20 to be designed to detect for example the quantity of frost and/or rime and/or ice and/or snow present on the window 2 and/or deliver information regarding the weather conditions.

The information regarding the quantity of frost and/or rime and/or ice and/or snow and/or the information regarding the weather conditions which is supplied by the detector 20 is received by the control unit 19, for example incorporated into the vehicle onboard electronics, and the control unit 19 if appropriate automatically initiates the sequences for melting the frost and/or rime and/or ice and/or snow and automatically adapts the number of sequences to be carried out according to the quantity of frost and/or rime and/or ice and/or snow on the window 2.

The control unit 19 also controls the length of pause of the blade between the two sequences or the pause of the blade when it is in the extreme position in a sequence.

The control unit 19 also controls the supply of heat from the blade to the window, namely whether this supply occurs while the blade is paused or alternatively continuously during the first and second sequence.

Various steps of the melting cycle using the system 21 will now be described with reference to FIGS. 2 to 4.

The method according to the invention begins from a state of rest, or parking position of the system 21, illustrated in FIG. 1.

The method according to the invention can be broken down into a succession of sequences. Depending on the embodiment chosen, and particularly when the heating is continuous, the system 21 causes heat to be supplied in order to melt the frost and/or rime and/or ice and/or snow present on the window 2.

As illustrated in FIG. 2, each of the sequences is defined by a movement of the wiper blade 1 between these successive positions:
a starting position PDₙ of the wiper blade 1,
an extreme position PEₙ of the wiper blade 1.

The movement of the blade between these two positions defines an associated swept area AB.

In the case of the first embodiment, as visible in FIG. 3, the blade 1 performs a first sequence, defining an area ABₙ, from the starting position PDₙ to the extreme position PEₙ. When the blade is in this extreme position PEₙ, the supply of heat is initiated via the control system 21 for a duration that is determined or related to the weather conditions. Next, as can also be seen in FIG. 3, the blade 1 returns to the starting position PDₙ. In a second sequence, defining an area ABₙ₊₁, the starting position PDₙ₊₁ will be identical to the starting position of the first sequence and the extreme position PEₙ₊₁ of this second sequence will lie at least partially outside the first swept area ABₙ. The starting position PDₙ is always the same whatever the sequence so that the number of times that the wiper blade 1 passes over the window 2 is high enough to prevent re-freezing.

In the case of the second embodiment, visible in FIG. 2a, the blade 1 performs a first sequence, defining an area ABₙ, from the starting position PDₙ to the extreme position PEₙ. When the blade is in this extreme position PEₙ, the supply of heat is initiated via the control system 21 for a duration that is determined or related to the weather conditions. Next, as FIG. 2b shows, the blade 1 covers a second sequence, defining an area ABₙ₊₁, from the starting position PDₙ₊₁ which coincides with the position PEₙ of the first sequence.

In both the first and second embodiments, the supply of heat by the wiper blade 1 to the window 2 occurs as soon as the blade reaches an extreme position. As an alternative, the melting cycle may also be performed continuously regardless of the position of the blade.

In the case of the third embodiment visible in FIGS. 3 and 4, the blade 1 performs in a first sequence, defining an area ABₙ, from the starting position PD, to the extreme position PEₙ. The extreme position PEₙ corresponds to a position in which the blade turns back. Specifically, as illustrated in FIG. 4, the starting position PDₙ₊₁ of a second sequence lies inside the swept area ABₙ associated with the first sequence performed immediately beforehand.

This starting position PDₙ₊₁ is set back from the extreme position PEₙ of the first sequence.

Moreover, still as illustrated in FIG. 4, the extreme position PEₙ₊₁ of the second sequence is situated entirely outside the first swept area ABₙ.

It will be appreciated that the zone of the window 2 between the positions PDₙ₊₁ and PEₙ is swept three times by the wiper blade 1, preventing re-freezing in this zone after the blade has passed.

The ratio between the surface area of this zone that is swept three times and that of the zone ABₙ is chosen for example according to the state of the window, notably according to the quantity of frost and/or rime and/or ice and/or snow present on the window.

Some of the sequences may be repeated before moving on to the next sequence, so as to ensure effective removal of the meltwater liquid.

Whatever the embodiment, the angular incrementation between the starting positions PD and the associated extreme positions PE is comprised for example between 1° and 10°, notably between 2° and 6°, being for example around 4°.

This angular incrementation may be constant from one sequence to the next. As an alternative, this incrementation may vary from one sequence to the next.

In the example described in the third embodiment, the supply of heat by the wiper blade 2 to the window 2 is maintained throughout the melting cycle but could just as well be initiated only when the blade reaches the extreme position PE for each sequence.

The wiper blade 1 used in the system 21 will now be described in greater detail.

According to one first embodiment of the invention, as illustrated in FIG. 5a, the wiper blade 1 comprises a longitudinal body 18 in which two cavities 15 are formed. These two cavities 15 are obtained at the time of manufacture of the wiper blade 1, for example during an extrusion operation, or alternatively are hollowed into this longitudinal body 18 in an additional step. Each cavity 15 has a cross section on a plane P perpendicular to the longitudinal axis 14 that is advantageously parabolic in shape.

The blade 1 further comprises two thermal elements 10 positioned one on either side of a blade rubber 13 of the wiper blade and are substantially symmetric with respect to one another about a plane R passing through the longitudinal axis 14 of the wiper blade. The blade rubber 13 is in contact with the window 2 and this blade rubber 13 has the effect of sweeping away any water residue present on this window 2. The longitudinal body 18 and the blade rubber 13 are advantageously coextruded and each made of elastic material suited to their uses, preferably semi-rigid plastics materials.

The thermal elements 10 each comprise a radiant body 11, notably made of ceramic, and a heating wire 12 encapsulated inside this radiant body 11. The thermal elements 10 extend over substantially the entire length of the wiper blade 1.

The two thermal elements 10 are each arranged in a respective cavity 15 of the wiper blade 1. The thermal elements 10 are situated substantially at the focus of the cavity 15 so as to emit optimum radiation toward the window 2. The cavity 15 extends over substantially the entire length of the wiper blade.

The two thermal elements 10 are able to operate simultaneously. The two thermal elements 10 are designed to emit radiation toward the window 2 when the wiper blade 1 is resting against this window 2. The radiation emitted by these thermal elements 10 is of sufficient intensity to melt the frost and/or rime and/or ice and/or snow present on the window 2 in a wiping zone of the blade.

The two cavities 15 are situated one on each side of the blade rubber 13 and are substantially symmetric with respect to one another about the plane R passing through the longitudinal axis 14 of the wiper blade. The cavity 15 is open toward the window 2 so that the thermal element 10 emits radiation toward the window 2. The cavity 15 is closed by a protective element 17 that allows the radiation emitted by the thermal element 10 to pass so as to protect the thermal element 10 from all kinds of external attack.

The thermal element 10 is arranged in such a way that it can be powered with electricity from a battery of the vehicle (the battery is not depicted in the figures).

The blade illustrated in FIG. 5b a cross section of FIG. 5a on plane P perpendicular to the longitudinal axis 14 of the wiper blade 1. The cavity 15 comprises a reflective wall 16 designed to reflect at least some of the radiation emitted by the filiform thermal element. This reflective wall 16 is situated at the closed end of the cavity 15, mimicking the shape of this cavity 15 and is advantageously made of aluminum.

FIG. 6 is an alternative form of FIG. 5a, the only difference being that in this embodiment of the invention the thermal element 10 has a shape that substantially mimics the cavity 15, notably a closed end of this cavity 15. The two thermal elements 10 are each made of a radiant wire 12 itself encapsulated in a ceramic body 11 and it is specifically this ceramic body that mimics the shape of the cavity 15.

Of course, the invention is not limited to the embodiments cited hereinabove and, for example, the supply of heat from the blade may be achieved by spraying a heated washer fluid. This spraying is for example performed through orifices formed on the body 18 of the wiper blade 1.

Thus, the invention seeks to cover the method for melting frost and/or rime and/or ice and/or snow present on a motor vehicle window using a wiper blade 1 designed to supply heat to the window 2 in a melting cycle associated with an upstroke or a downstroke of the blade, according to one of the three embodiments described hereinabove. It should be understood that the description of the blade given with reference to FIGS. 5a, 5b and 6 is common to all these embodiments.

1. A method for melting frost, rime, ice and/or snow present on a motor vehicle window, using a wiper blade designed to supply heat to the window in a melting cycle associated with an upstroke or downstroke of the blade, the method comprising:
causing the wiper blade to supply heat to the window so that the supply of heat causes the frost, rime, ice and/or snow present on the vehicle window to melt;
in a first sequence, moving the wiper blade to sweep a first swept area, the first area being delimited by a starting position of the blade and an extreme position of the blade in this first sequence; and
in a second sequence, moving the wiper blade to sweep a second swept area delimited by a starting position of the blade and an extreme position of the blade in this second sequence,
wherein the first sequence and the second sequence cause the blade to move in the same direction in the same melting cycle.

2. The method as claimed in claim 1, wherein the starting position in the first sequence is distinct from the starting position in the second sequence.

3. The method as claimed in claim 2, wherein the starting position in the second sequence is identical to the extreme position in the first sequence.

4. The method as claimed in claim 2, wherein the starting position for the second sequence is situated at least partially inside the first swept area, set back from the extreme position of the first sequence.

5. The method as claimed in claim 1, wherein the starting position in the first sequence is identical to the starting position in the second sequence.

6. The method as claimed in claim 4, wherein the extreme position for the second sequence is situated at least partially outside the first swept area.

7. The method as claimed in claim 1, wherein the blade pauses between the first and second sequence.

8. The method as claimed in claim 1, wherein the blade pauses when the blade is in its extreme position in a sequence.

9. The method as claimed in claim 7, wherein the pause is predetermined, and comprises between 3 and 6 seconds.

10. The method as claimed in claim 7, wherein the pause is dependent on information relating to the state of the window and/or the weather conditions.

11. The method as claimed in claim 7, wherein the supply of heat to the window by the wiper blade occurs during the pause.

12. The method as claimed in claim 1, wherein the supply of heat to the window by the wiper blade occurs continuously during the first sequence and the second sequence.

13. The method as claimed in claim 10, wherein the supply of heat is achieved by thermal radiation or by spraying a heated liquid.

14. The method as claimed in claim 1, wherein the number of sequences needed to perform a melting cycle is predetermined, as a minimum of 5.

15. The method as claimed in claim 1, wherein the number of sequences in the melting cycle is dependent on information relating to the state of the window and/or weather conditions.

16. The method as claimed in claim 14, wherein after a predetermined number of sequences performed, the blade returns to the starting position of the first sequence.

17. The method as claimed in claim 15, wherein after a number of sequences performed that is dependent on information relating to the state of the window and/or weather conditions, the blade returns to the starting position of the first sequence.

18. The method as claimed in claim 1, wherein this method can be initiated/controlled remotely away from the motor vehicle.

19. The method as claimed in claim 1, wherein the first sequence is immediately followed by the second sequence.

20. The method as claimed in claim 1, wherein the first sequence is initiated at least twice in succession before the second sequence is begun.

21. A system for melting frost, rime, ice and/or snow present on a motor vehicle window, using a wiper blade designed to supply heat to the window according to a melting cycle associated with an upstroke or downstroke of the blade, the system comprising:
the wiper blade able to melt the frost, rime, ice and/or snow present on the vehicle window;
a control unit configured to actuate the blade in the following steps:
causing the wiper blade to supply heat to the window so that this supply of heat causes the frost and/or rime and/or ice and/or snow present on the vehicle window to melt, wherein the supply of heat is achieved by thermal radiation or the spraying of a heated liquid,
in a first sequence, moving the wiper blade so as to sweep a first swept area, this first area being delimited by a starting position of the blade and an extreme position of the blade in this first sequence,
in a second sequence, moving the wiper blade to sweep a second swept area delimited by a starting position of the blade and an extreme position of the blade in this second sequence,
wherein the first sequence and the second sequence cause the blade to move in the same direction in the same melting cycle.

22. A wiper blade for a vehicle window, comprising:
at least one thermal element designed to emit radiation toward the window when the blade is resting against the window, the radiation being of sufficient intensity to cause the frost, rime, ice and/or snow present on the window to melt in a wiping zone of the blade.

23. The blade as claimed in claim 22, wherein the thermal element is a radiant element.

24. The blade as claimed in claim 22, further comprising at least two thermal elements.

25. The blade as claimed in claim 22, wherein the thermal element extends over substantially the majority of the length of the blade.

26. The blade as claimed in claim 22, wherein the thermal element is arranged on the blade in such a way as to be able to be powered with electrical energy from the vehicle in order to emit radiation.
